(19) United States
(12) Patent Application Publication
(10) Pub. No.: US 2014/0019926 A1
(43) Pub. Date: Jan. 16, 2014

(54) DESIGN SUPPORT METHOD AND DESIGN SUPPORT APPARATUS

(71) Applicant: Fujitsu Limited, Kawasaki-shi (JP)

(72) Inventor: Takumi MIYASHITA, Inagi (JP)

(73) Assignee: Fujitsu Limited, Kawasaki-shi (JP)

(21) Appl. No.: 14/025,444

(22) Filed: Sep. 12, 2013

Related U.S. Application Data
(63) Continuation of application No. PCT/JP2011/057580, filed on Mar. 28, 2011.

(51) Int. Cl. G06F 17/50

(52) U.S. Cl. CPC G06F 17/5009
USPC 716/107

(57) ABSTRACT

A determining unit determines parameters indicating a relation among voltages and currents at input and output of each of a non-linear device model provided in a high frequency circuit model having a non-linear device and a circuit model of a passive element connected to the non-linear device model. A calculating unit calculates amplitude and phase of a voltage source providing a fundamental wave of an equivalent circuit model, based on an input power and an impedance matching condition preliminarily determined by a designer and parameters determined by the determining unit. In addition, the calculating unit calculates amplitude and phase of a voltage source providing a harmonic wave of the equivalent circuit model, based on a harmonic termination condition preliminarily determined by the designer and the parameters determined by the determining unit.

### CROSS-REFERENCE TO RELATED APPLICATION

This application is a continuation application of International Application PCT/JP2011/057580 filed on Mar. 28, 2011 which designated the U.S., the entire contents of which are incorporated herein by reference.

### FIELD

The embodiments discussed herein relate to a design support method and a design support apparatus.

### BACKGROUND

With the purpose of reducing power consumption in a high frequency circuit, there is desired a method of operating a non-linear circuit such as a power amplifier with an efficiency as high as possible.

FIG. 8 illustrates an exemplary circuit which measures the input/output impedance of a non-linear circuit.

A circuit 90 illustrated in FIG. 8 is provided with a DUT 91 which is a non-linear circuit. At the input side of the DUT 91, there are provided a voltage source 92 which outputs a fundamental wave, and voltage sources 93 and 94 which respectively output second and third harmonic waves. In addition, there are also provided at the output side of the DUT 91 a voltage source 95 which outputs a fundamental wave, and voltage sources 96 and 97 which respectively output second and third harmonic waves.

When evaluating output power, efficiency, or the like, the output power or efficiency is measured at each point for a combination of the fundamental wave and harmonic waves at the input and the output sides of the circuit 90, for example, while scanning across the impedance plane with the first and higher-order impedance being sequentially varied. A contour line of the measured characteristic value is then plotted on the impedance plane, and a person viewing the contour line determines a point to be selected. According to the method, the input/output impedance provided to the DUT 91 may be freely determined, allowing the output power or efficiency of the DUT 91 to be evaluated while varying the input/output impedance.

A. Mallet et al., “A DESIGN METHOD FOR EFFICIENCY CLASS F HBT AMPLIFIERS”, IEEE MTT-S Digest, 1996, pp. 855-858

The first and higher-order impedance matching condition and the harmonic termination condition of a non-linear high frequency circuit are not independent of, but are related to, each other. Therefore, there is a problem that determining the phase and the amplitude of the voltage source based on an overall evaluation by a designer with regard to many results may give rise to a complicated procedure.

### SUMMARY

According to an aspect of the embodiments, there is provided a design support method including: determining, by a design support apparatus, parameters indicating a relation among voltages and currents at input and output of each of a non-linear device model provided in a circuit model under inspection and a circuit model of a passive element connected to the non-linear device model; calculating, by the design support apparatus, a voltage of a voltage source providing a fundamental wave of the circuit model under inspection, based on a given input power condition and an impedance matching condition for the circuit model under inspection and the calculated parameters; and calculating, by the design support apparatus, a voltage of a voltage source providing harmonic wave of the circuit model under inspection, based on a given harmonic termination condition and the determined parameters.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a design support apparatus of a first embodiment;

FIG. 2 illustrates an exemplary hardware configuration of a design support apparatus of a second embodiment;

FIG. 3 is a block diagram illustrating a function of the design support apparatus of the second embodiment;

FIG. 4 illustrates an exemplary circuit model under inspection;

FIG. 5 illustrates an equivalent circuit model;

FIG. 6 is a flowchart describing a procedure of the design support apparatus of the second embodiment;

FIG. 7 is a flowchart describing a procedure of a design support apparatus of a third embodiment; and

FIG. 8 illustrates an exemplary circuit which measures input/output impedance of a non-linear circuit.

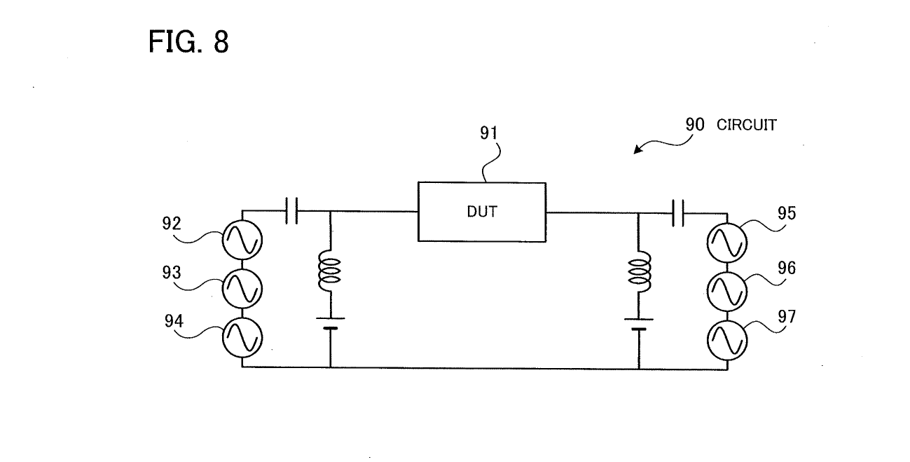

### DESCRIPTION OF EMBODIMENTS

Several embodiments of a design support apparatus will be described below with reference to the accompanying drawings, wherein like reference numerals refer to like elements throughout. In a first embodiment, a form of implementing the design support apparatus of the disclosure will be described and subsequently, in second and third embodiments, the design support apparatus of the disclosure will be described more specifically.

### First Embodiment

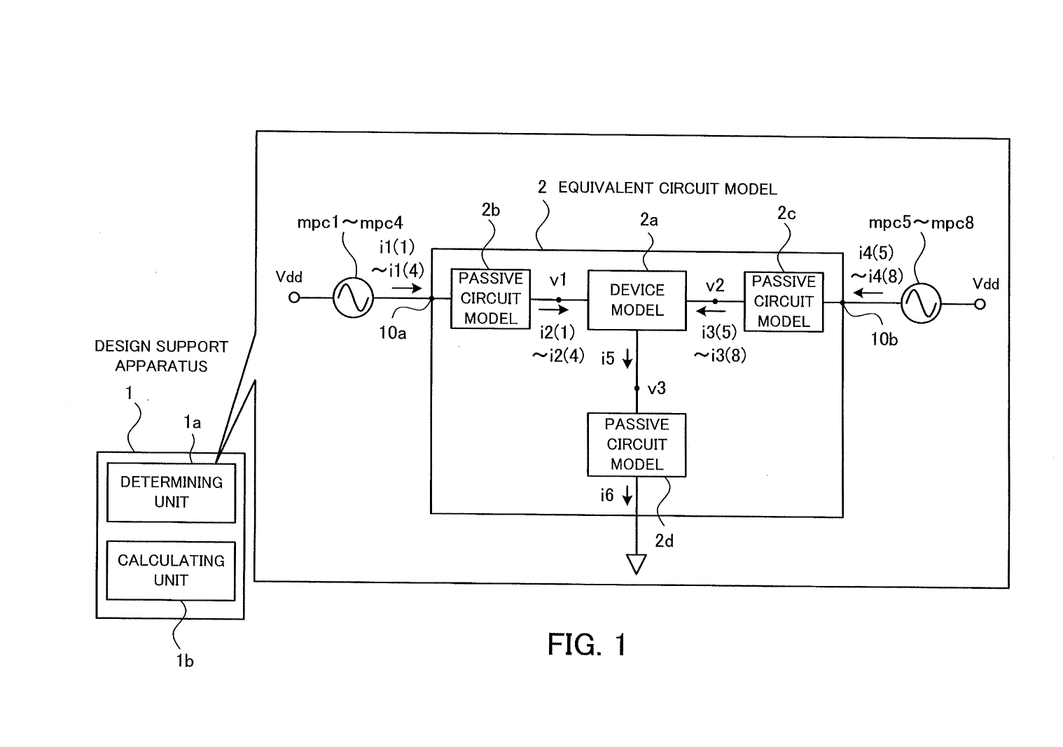

FIG. 1 illustrates a design support apparatus of a first embodiment.

A design support apparatus (computer) 1 of the first embodiment has a determining unit 1a and a calculating unit 1b.

The determining unit 1a determines parameters indicating a relation among voltages and currents at input and output of each of a non-linear device model provided in a high-frequency circuit model (referred to as a “circuit model under inspection” in the following) provided with a non-linear device and a circuit model of a passive element connected to the non-linear device model. In the present embodiment, the parameters are determined using an equivalent circuit model of the circuit model under inspection. FIG. 1 illustrates an exemplary equivalent circuit model. An input terminal 10a of the equivalent circuit model 2 has voltage sources mpc1 to mpc4 series-connected thereto. FIG. 1 illustrates a single voltage source for space limitations. The voltage source mpc1 provides a fundamental wave, and voltage sources mpc2 to mpc4 provide the second to the fourth-order harmonic termination conditions, respectively. In addition, the output terminal 10b of the equivalent circuit model 2 has voltage sources mpc5 to mpc8 series-connected thereto. FIG. 1 illustrates a single voltage source for space limitations. The voltage source mpc5 provides a fundamental wave, and voltage sources mpc6 to mpc8 provide the second to the fourth-order harmonic termination conditions, respectively.

The equivalent circuit model 2 has a device model 2a and passive circuit models 2b, 2c and 2d.

The device model 2a is a model of a non-linear device provided in the circuit model under inspection. The device model 2a has a current source and a voltage source.

The passive circuit model 2b is a model of impedance of the wire of the circuit model under inspection between the input terminal 10a and the device model 2a, and impedance across the wiring. The passive circuit model 2c is a model of impedance of the wire of the circuit model under inspection between the device model 2a and the output terminal 10b, and impedance across the wiring. In addition, the passive circuit model 2d is a model of impedance of the wire of the circuit model under inspection between the device model 2a and the ground (GND), and impedance across the wiring.

The determining unit 1a obtains fundamental wave components and higher-order components of the voltage and the current at respective contact points of the device model 2a and the passive circuit models 2b to 2d by measuring a circuit that embodies the circuit model under inspection, or performing circuit simulation of the circuit model under inspection. As fundamental wave components and higher-order components of the voltage and the current to be obtained, there are, for example, input currents i1(1) to i1(4) of the passive circuit model 2b, input currents i2(1) to i2(4) and i3(5) to i3(8) of the device model 2a, input currents i4(5) to i4(8) of the passive circuit model 2c, an input current i5 of the passive circuit model 2d, an output current i6 of the passive circuit model 2d, a voltage v1 between the device model 2a and the passive circuit model 2b, a voltage v2 between the device model 2a and the passive circuit model 2c, a voltage v3 between the device model 2a and the passive circuit model 2d, or the like. Here, the numbers in the parentheses correspond to the voltage sources mpc1 to mpc8. For example, i1(1) denotes the input current of the passive circuit model 2b caused by the voltage source mpc1. In addition, i1(2) denotes the input current of the passive circuit model 2b caused by the voltage source mpc2.

The determining unit 1a then obtains parameters indicating the relation among voltages and currents at input and output of each of the device model 2a and the passive circuit models 2b, 2c and 2d, based on the obtained fundamental wave components and the higher-order components of the voltage and the current at respective contact points. As parameters to be obtained, there are, for example, the g parameters, the y parameters, or the like of the passive circuit model 2c, regarding the passive circuit model 2c as a two-terminal pair circuit.

The calculating unit 1b calculates the amplitude and the phase of the voltage sources mpc1 and mpc5 providing the fundamental wave of the equivalent circuit model 2, based on the input power and impedance matching condition preliminarily determined by a designer and the parameters determined by the determining unit 1a. In addition, the calculating unit 1b calculates the amplitude and the phase of the voltage sources mpc2 to mpc4 and the voltage sources mpc6 to mpc8 providing harmonic waves of the equivalent circuit model 2 based on the harmonic termination condition preliminarily determined by the designer and the parameters determined by the determining unit 1a.

The calculating unit 1b may recalculate the parameters of the equivalent circuit model 2, based on the determined amplitude and phase of the voltage sources mpc1 to mpc8. As a determination criterion for recalculation, for example, the determination may be performed according to whether the amplitude and the phase of the voltage sources mpc1 to mpc8 settle within a certain range.

According to the design support apparatus 1, the voltage of the voltage source in a non-linear high frequency circuit may be obtained by calculation. Therefore, the determination time of the phase and the amplitude of the voltage source in a non-linear high frequency circuit may be reduced in comparison with determining, by the designer for example, the voltage of the voltage source based on the measured value. In addition, the possibility that voltage sources mpc1 to mpc8 satisfying the impedance matching condition, the harmonic termination condition, or the like may be raised by attempting to settle the amplitude and the phase of the voltage sources mpc1 to mpc8 by recalculating the parameters of the equivalent circuit model 2.

The determining unit 1a and the calculating unit 1b may be realized by the function provided in the CPU (Central Processing Unit) included in the design support apparatus 1. In addition, a storage area for storing the voltage sources mpc1 to mpc8 and the equivalent circuit model 2 may be realized by a data storage area provided in a RAM (Random Access Memory), a hard disk drive (HDD), or the like included in the design support apparatus 1.

### Second Embodiment

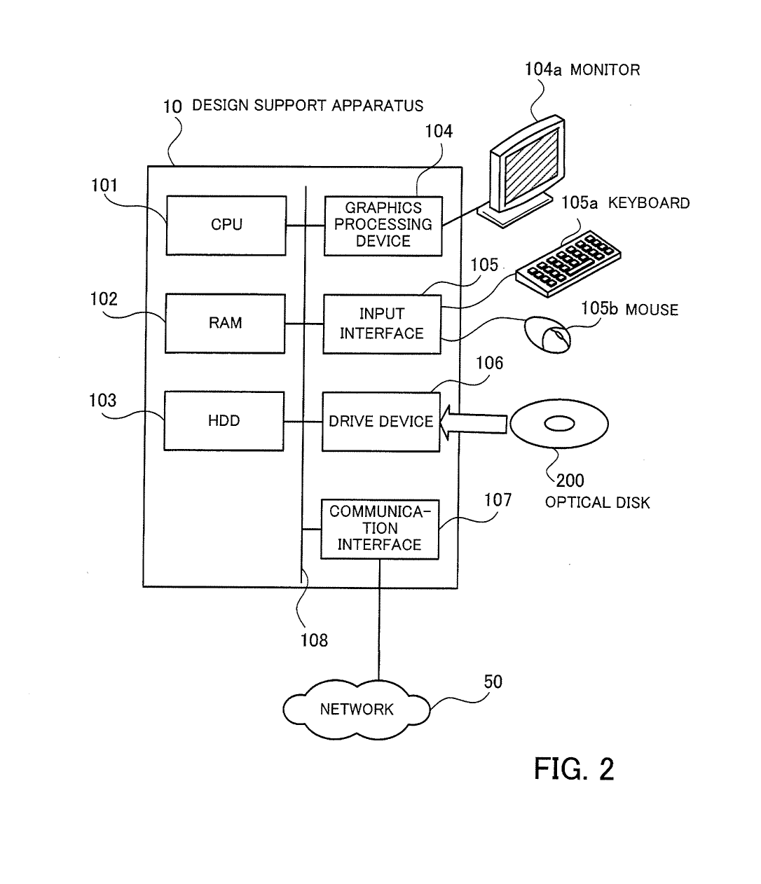

FIG. 2 illustrates an exemplary hardware configuration of a design support apparatus of a second embodiment. The design support apparatus 10 is controlled as a whole by a CPU 101. The CPU 101 has a RAM 102 and a plurality of peripheral devices connected thereto via a bus 108.

The RAM 102 is used as the main storage device of the design support apparatus 10. At least a part of the programs of the OS (Operating System) or application programs to be executed by the CPU 101 is temporarily stored in the RAM 102. In addition, the RAM 102 has stored therein a variety of data to be used for processing by the CPU 101.

As peripheral devices connected to the bus 108, there are a hard disk drive 103, a graphics processing device 104, an input interface 105, a drive device 106, and a communication interface 107.

The hard disk drive 103 magnetically reads and writes data from and to a built-in disk. The hard disk drive 103 is used as a secondary storage device of the design support apparatus 10. The hard disk drive 103 has stored therein programs of the OS, application programs, and a variety of data. As a secondary storage device, a semiconductor storage device such as a flash memory may be used.

The graphics processing device 104 has a monitor 104a connected thereto. The graphics processing device 104 displays an image on the screen of the monitor 104a according to an instruction from the CPU 101. As the monitor 104a, there is a liquid crystal display device or the like using a CRT (Cathode Ray Tube).

The input interface 105 has a keyboard 105a and a mouse 105b connected thereto. The input interface 105 transmits, to the CPU 101, signals which have been sent from the keyboard 105a and the mouse 105b. The mouse 105b is an exemplary pointing device and may be replaced by other pointing devices. As other pointing devices, there are a touch panel, a tablet, a touchpad, a track ball, or the like.

The drive device 106 reads data recorded on a portable storage medium such as an optical disk having data recorded thereon in a manner readable by reflection of light, a USB (Universal Serial Bus) memory, or the like. For example, when the drive device 106 is an optical drive device, reading of data recorded on an optical disk 200 is performed using laser beam or the like. As the optical disk 200, there are a Blu-ray (registered trademark), a DVD (Digital Versatile Disc), a DVD-RAM, a CD-ROM (Compact Disc Read Only Memory), a CD-R (Recordable)/RW (ReWritable), or the like.

The communication interface 107 is connected to a network 50. The communication interface 107 transmits and receives data to and from other computers or communication devices via the network 50. The hardware configuration described above allows the processing function of the present embodiment to be realized.

The design support apparatus 10 of such a hardware configuration is provided with the following functions.

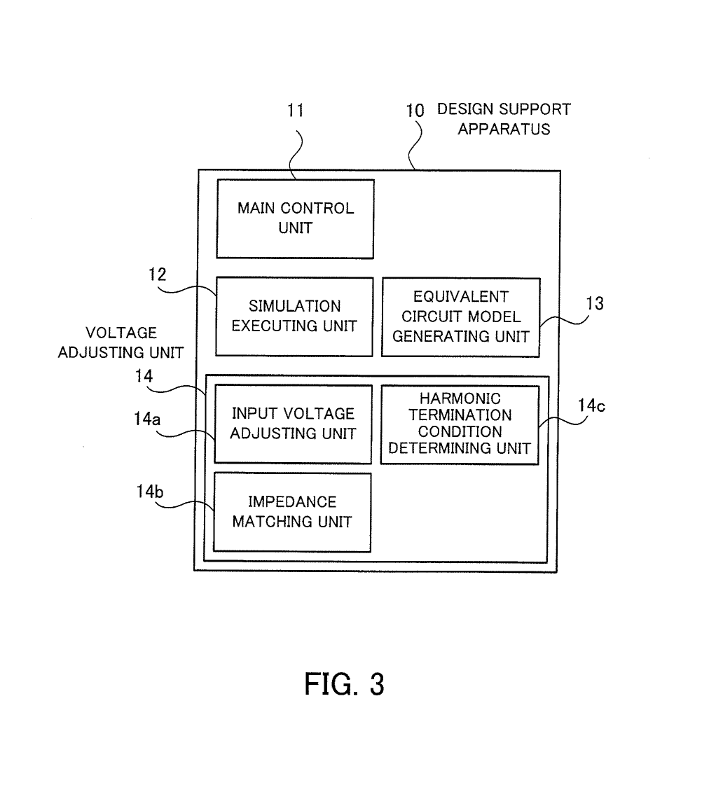

FIG. 3 is a block diagram illustrating a function of the design support apparatus of the second embodiment.

The design support apparatus 10 has a main control unit 11, a simulation executing unit 12, an equivalent circuit model generating unit 13, and a voltage adjusting unit 14.

The main control unit 11 determines the amplitude and phase of the voltage source supplying the fundamental wave and harmonic waves in a circuit model under inspection by providing instructions to the simulation executing unit 12, the equivalent circuit model generating unit 13, and the voltage adjusting unit 14.

According to an instruction from the main control unit 11, the simulation executing unit 12 performs simulation of the circuit model under inspection having a non-linear device model of an amplification element.

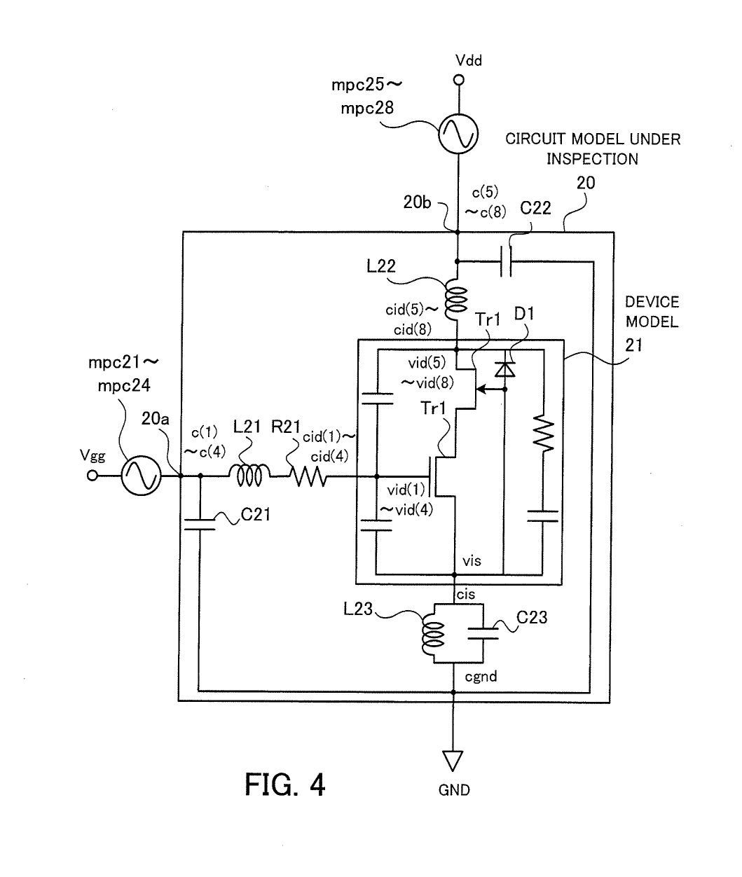

FIG. 4 illustrates an exemplary circuit model under inspection.

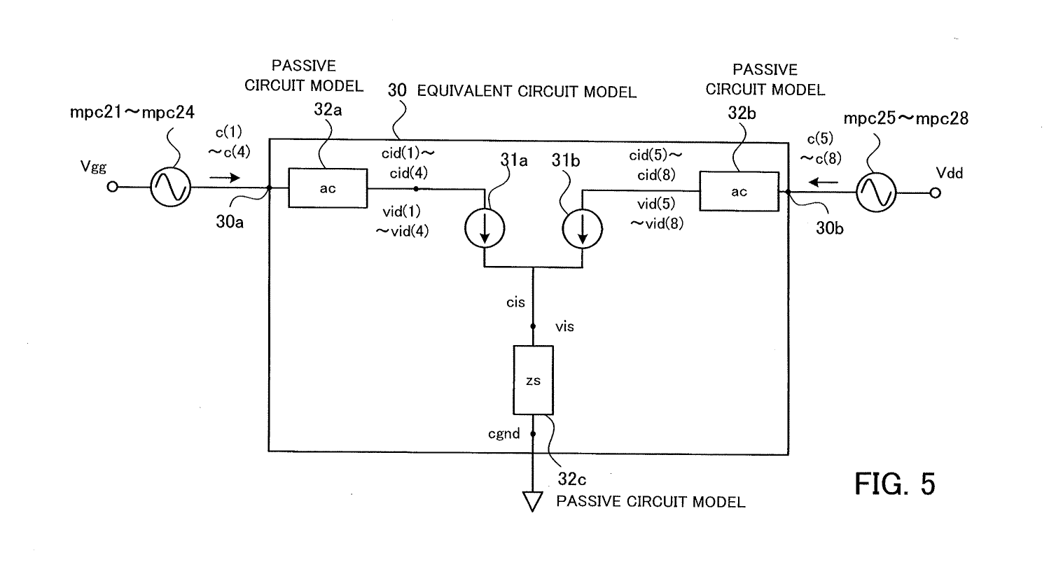

Each of the input and the output terminals of the circuit model under inspection 20 has the same number of voltage sources series-connected thereto. FIG. 4 illustrates a single voltage source connected to each of the input and the output terminals, for space limitations. The same goes for FIG. 5 described below. Specifically, the input terminal 20a of the circuit model under inspection 20 has series-connected thereto the voltage source mpc21 outputting the fundamental wave of the input signal, and the voltage sources mpc22 to 24 respectively providing the second to the fourth-order harmonic termination conditions. In addition, the output terminal 20b of the circuit model under inspection 20 has series-connected thereto the voltage source mpc25 outputting the fundamental wave of the output signal, and the voltage sources mpc26 to 28 respectively providing the second to the fourth-order harmonic termination condition. In the following, the voltage values of the voltage sources mpc21 to mpc28 are denoted as mpc(1) to mpc(8). Given the voltage values at the input side mpc(1) to mpc(n), the voltage values at the output side are mpc(n+1) to mpc(2n).

The circuit model under inspection 20 has a device model 21 of a non-linear device of an amplification element; a capacitor C21, a resistor R21, and an inductor L21 that are a model of passive elements at the input side of the device model 21; a capacitor C22 and an inductor L22 that are a model of passive elements at the output side of device model 21; and a capacitor C23 and an inductor L23 that are a model of passive elements between the device model 21 and the GND.

Currents c(1) to c(4) illustrated here in FIG. 4 are respectively the first to the fourth-order currents from the voltage sources mpc21 to mpc24 to the input terminal 20a. In addition, currents c(5) to c(8) are respectively the first to the fourth-order currents from the voltage sources mpc25 to mpc28 to the output terminal 20b. Currents cid(1) to cid(4) are respectively the first to the fourth-order gate currents of a transistor Tr1 of the device model 21, and currents cid(5) to cid(8) are respectively the first to the fourth-order drain currents of the transistor Tr1 of the device model 21. Voltages vid(1) to vid(4) are respectively the first to the fourth-order gate voltages of the transistor Tr1 of the device model 21, and voltages vid(5) to vid(8) are respectively the first to the fourth-order drain voltages of the transistor Tr1 of the device model 21.

Current cis is a source current of the transistor Tr1 of the device model 21. The current cis varies according to the combination of the currents cid(1) to cid(8). Voltage vis is the source voltage of the transistor Tr1 of the device model 21. The voltage vis varies according to the combination of the voltages vid(1) to vid(8). Current cgnd is the current between a passive circuit model 32c and the GND.

According to an instruction from the main control unit 11, the equivalent circuit model generating unit 13 generates an equivalent circuit model, based on the result of simulation performed by the simulation executing unit 12. The equivalent circuit model generating unit 13 is an example of the determining unit.

FIG. 5 illustrates the equivalent circuit model.

An input terminal 30a of an equivalent circuit model 30 has the voltage sources mpc21 to mpc24 series-connected thereto. In addition, an output terminal 30b of the equivalent circuit model 30 has the voltage sources mpc25 to mpc28 connected thereto. The equivalent circuit model 30 has current sources 31a and 31b, and passive circuit models 32a, 32b and 32c. The current sources 31a and 31b are models of the device model 21. All the passive circuit models 32a, 32b and 32c are linear models. The passive circuit model 32a is a model of the capacitor C21, the resistor R21, and the inductor L21. The passive circuit model 32b is a model of the capacitor C22 and the inductor L22. The passive circuit model 32c is a model of the capacitor C23 and the inductor L23.

The equivalent circuit model generating unit 13 provides the equivalent circuit model 30 with a current value and a voltage value of each contact point obtained by simulating the circuit model under inspection 20. In FIG. 5, the current value and the voltage value of the contact points corresponding to FIG. 4 bear the same reference numerals as those in FIG. 4.

The voltage adjusting unit 14 determines the amplitude and the phase of the voltage sources mpc21 to mpc28 by calculation using the equivalent circuit model 30. The voltage adjusting unit 14 has an input voltage adjusting unit 14a, an impedance matching unit 14b, and a harmonic termination condition determining unit 14c.

The impedance matching unit 14b performs a process of settling the value of the voltage value mpc(1) of the voltage source mpc21 by repetitively performing the process of recalculating the voltage value mpc(1) using the voltage value mpc(1) obtained in the previous iteration.

The impedance matching unit 14b performs a process of settling the value of the voltage value mpc(5) of the voltage source mpc25 by repetitively performing the process of recalculating the voltage value mpc(5) using the voltage value mpc(5) obtained in the previous iteration.

The harmonic termination condition determining unit 14c determines the voltage values mpc(2) to mpc(4) of the voltage sources mpc22 to mpc24 and the voltage values mpc(6) to mpc(8) of the voltage sources mpc26 to mpc28, based on the harmonic termination condition at the gate contact point and the drain contact point of the device model 21.

In the following, a method of determining the voltage value mpc(1) of the voltage source mpc21, a method of determining the voltage value mpc(5) of the voltage source mpc25, a method of determining the voltage values mpc(2) to mpc(4) of the voltage sources mpc22 to mpc24, and a method of determining the voltage values mpc(6) to mpc(8) of the voltage sources mpc26 to mpc28 will be described in sequence.

<Determination Method of the Voltage Value mpc(1)>

The input voltage adjusting unit 14a obtains the power pinm of the signal input to the equivalent circuit model 30 by the following equation (1) using the voltage value mpc(1) of the previously obtained voltage source mpc21 and the value of the current c(1) between the voltage source mpc21 and the passive circuit model 32a. The asterisk in the equation (1) indicates the complex conjugate. The initial value of the voltage value mpc(1) provides a value (e.g., 1 mV) determined by the designer.

$$pinm = \frac{mpc * ( 1 ) c ( 1 ) + mpc ( 1 ) c * ( 1 )}{4} \qquad ( 1 )$$

The input voltage adjusting unit 14a determines, as the value of the voltage source mpc21 to be used for the next simulation, a value resulting from multiplying the present voltage value mpc(1) of the voltage source mpc21 by the square root of the ratio of the target input power pino provided by the designer to the power pinm obtained in the equation (1). The voltage value mpc′(1) is obtained by executing the following equation (2) by the input voltage adjusting unit 14a.

mpc′(1)=mpc(1)\sqrt{pino/pinm} (2)

<Determination Method of the Voltage Value mpc(5) by Output Power Matching>

Next, a method of obtaining the voltage value mpc(5) of the voltage source mpc25 providing the maximum output power will be described. First, the impedance matching unit 14b obtains parameters (the g parameters of a two-terminal pair circuit) gac5 of the passive circuit model 32a. The parameters gac5 may be obtained by the following equation (3) using the voltage value mpc(5) of the voltage source mpc25, the value of the current c(5) between the voltage source mpc25 and the passive circuit model 32b, the value of the current cid(5) between the passive circuit model 32b and the current source 31b, and the value of the voltage vid(5) between the passive circuit model 32b and the current source 31b.

$$gac 5 = ( \begin{matrix}c ( 5 ) / mpc ( 5 ) & c ( 5 ) / ( - cid ( 5 ) \\ vid ( 5 ) / mpc ( 5 ) & vid ( 5 ) / ( - cid ( 5 )\end{matrix} ) \qquad ( 3 )$$

Here, the output power pout may be obtained by the following equation (4).

pout=(mpc(5)c*(5)+mpc*(5)c(5))/4 (4)

Therefore, the impedance matching unit 14b obtains, by the following equations (5) and (6), the voltage source mpc(5) to be substituted in the equation (3) of the next iteration, from a condition that the output power pout of the equation (4) becomes largest.

$$\begin{matrix}R ( {mpc}^{′} ( 5 ) ) = \frac{\begin{matrix}- ( R ( gac 5 ( 1 , 2 ) ) R ( - cid ( 5 ) ) + \\ I ( gac 5 ( 1 , 2 ) ) I ( cid ( 5 ) ) )\end{matrix}}{2 R ( gac 5 ( 1 , 1 ) )} & ( 5 ) \\ I ( {mpc}^{′} ( 5 ) ) = \frac{\begin{matrix}- ( I ( gac 5 ( 1 , 2 ) ) R ( - cid ( 5 ) ) + \\ R ( gac 5 ( 1 , 2 ) ) I ( cid ( 5 ) ) )\end{matrix}}{2 R ( gac 5 ( 1 , 1 ) )} & ( 6 )\end{matrix}$$

Here, gac5 (1,2) and (1,1) indicate the value of the position in the matrix of the equation (3). In addition, I( ) indicates the imaginary part and R( ) indicates the real part.

<Determination Method of the Voltage Value mpc(5) by Output Efficiency Matching>

Next, a method of obtaining the voltage value mpc(5) of the voltage sources mpc25 providing the maximum efficiency will be described. First, the impedance matching unit 14b obtains the parameters gac5 using the equation (3) described above.

Next, the present embodiment provides a condition in which the loss of the device model 21 is the smallest so as to raise the drain efficiency (the ratio of the effective output to the last stage transistor input). It suffices that the phase of the voltage vid(5) of the device model 21 is the inverse of the phase of the current cid(5). Therefore, using the following equation (7),

$$( \begin{matrix}c ( 5 ) \\ vid ( 5 )\end{matrix} ) = gac 5 ( \begin{matrix}mpc ( 5 ) \\ cid ( 5 )\end{matrix} ) \qquad ( 7 )$$

the impedance matching unit 14b obtains the voltage value mpc′(5) to be substituted in the equation (3) from the following equations (8) and (9) when obtaining the parameters gac5 of the next iteration by the equation (3).

$$\begin{matrix}R ( {mpc}^{′} ( 5 ) ) = \frac{\begin{matrix}R ( - cid ( 5 ) I ( gac 5 ( 2 , 2 ) I ( gac 5 ( 2 , 1 ) ) - \\ R ( gac 5 ( 2 , 1 ) ) I ( gac 5 ( 2 , 2 ) ) I ( cid ( 5 ) )\end{matrix}}{{R ( gac 5 ( 2 , 1 ) )}^{2} + {I ( gac 5 ( 2 , 1 ) )}^{2}} & ( 8 ) \\ I ( {mpc}^{′} ( 5 ) ) = \frac{\begin{matrix}R ( gac 5 ( 2 , 1 ) I ( gac 5 ( 2 , 2 ) ) R ( cid ( 5 ) ) - \\ I ( gac 5 ( 2 , 1 ) ) I ( gac 5 ( 2 , 2 ) ) I ( cid ( 5 ) )\end{matrix}}{{R ( gac 5 ( 2 , 1 ) )}^{2} + {I ( gac 5 ( 2 , 1 ) )}^{2}} & ( 9 )\end{matrix}$$

<Determination Method of the Voltage Values mpc(2) to mpc(4) and the Voltage Values mpc(6) to mpc(8) by Harmonic Termination Condition>

In a class-F or an inverse class-F amplifier, there occurs a reflection (harmonic termination condition being htc(i)=1) due to high impedance, or a reflection (harmonic termination condition being htc(i)=−1) due to low impedance, of respective harmonic waves at the gate and drain contact points of the device model 21 according to a class-ht vector (denoted as “htc” in the following). The argument i is assumed to be i=2, 3, 4 for the orders 2, 3, 4 of the voltage sources mpc22 to 24. In addition, for the orders 2, 3, 4 of the voltage sources mpc26 to 28, it is assumed that i=6, 7, 8. In general, the argument i is assumed to be i=2, 3, . . . , n for the orders 2, 3, . . . n of the voltage sources mpc22 to 2(n). In addition, it is assumed that i=n+2, n+3, . . . , 2n for the orders 2, 3, . . . n of the voltage sources mpc26 to 2(n).

Here, the phase relation between respective orders of harmonic waves of the voltage sources mpc22 to mpc24 and harmonic waves of the voltage sources mpc26 to mpc28 is an inverse relation at the gate and drain contact points of the device model 21.

In the present embodiment, it is assumed that htc=[0,1,−1,0,−1,1] in the class-F. The numbers in the brackets [] correspond, from left to right, to the orders of the voltage sources mpc22 to 24 and the voltage sources mpc26 to 28, respectively. For the fifth and higher orders, the numbers in the brackets are repeatedly substituted for the voltage sources at the input side and the output side, respectively. For example, when the voltage sources at the input side and the output side are respectively of order 7, it is assumed that htc=[0,1,−1,0,1,−1,0,−1,1,0,−1,1,].

In addition, for the inverse class-F in which wave patterns of the current and the voltage of class-F are interchanged, it is assumed that htc=[0,−1,1,0,1,−1]. The harmonic termination condition for the fundamental wave is assumed to be htc(1)=0.

In the present embodiment, assuming that the target values of the voltage vid and the current cid which realize reflection due to high impedance (htc(i)=1) or reflection due low impedance (htc(i)=−1) are respectively vid′ and cid′, a relation is defined by the following equations (10) and (11).

vid′=(F+1).*vid (10)

cid′=(1−F)/2.*cid′= (11)

Here, [.*] indicates the product for each order.

Accordingly, the harmonic termination condition determining unit 14c determines the voltage values mpc(2) to mpc(4) and the voltage values mpc(6) to mpc(8) so that the voltage vid and the current cid satisfy the relation of the equations (10) and (11). Specifically, the harmonic termination condition determining unit 14c calculates the following equations (13) and (15).

Since the reflection due to low impedance (htc(i)=−1) results in the output voltage vid(i)=0, the relation of the following equation (12) is satisfied assuming mpc′(i)=v(i).

vid(i)=gaci(2,1)v(i)+gaci(2,2)cid(i)=0 (12)

According to the equation (12), |vid(n)|=nvdd/2 substantially holds when htc=[0,1,−1,0,−1,1]. In addition, |vid(n)|=2nvdd substantially holds when htc=[0,−1,1,0,1,−1].

Here, gaci(2,1) indicates the value at the second row and first column of the g parameters of the passive circuit model 32a for the voltage value mpc(i). For example, gac2(2,1) indicates the value at the second row and first column of the g parameters of the passive circuit model 32a for the voltage value mpc(2) of the voltage source mpc22. In addition, for example, gac7(2,1) indicates the value at the second row and first column of the g parameters of the passive circuit model 32b for the voltage value mpc(7) of the voltage source mpc27.

The harmonic termination condition determining unit 14c obtains the amplitude and the phase of the voltage source mpc′(i) by the following equation (13) which is a transformation of the equation (12).

$${mpc}^{′} ( i ) = \frac{- gaci ( 2 , 2 ) cid ( i )}{gaci ( 2 , 1 )} \qquad ( 13 )$$

Since cid(i)=0 holds in the reflection due to high impedance (htc(i)=1), the relation of the following equation (14) is satisfied.

cid(i)=yaci(2,1)v(i)+yaci(2,2)vid(i)=0 (14)

Here, yac indicates the y parameters (admittance matrix) of the passive circuit models 32a and 32b.

Accordingly, the harmonic termination condition determining unit 14c obtains the amplitude and the phase of the voltage source mpc′(i) by the following equation (15).

$${mpc}^{′} ( i ) = \frac{- yaci ( 2 , 2 ) vid ( i )}{yaci ( 2 , 1 )} \qquad ( 15 )$$

The simulation of the circuit model under inspection 20 is repeated using the voltage value mpc(1) of the voltage source mpc21, the voltage value mpc(5) of the voltage source mpc25, the voltage values mpc(2) to mpc(4) of the voltage sources mpc22 to mpc24, and the voltage values mpc(6) to mpc(8) of the voltage sources mpc26 to mpc28 obtained by the method described above. Repeating the simulation allows the amplitude and the phase of the voltage sources mpc21 to mpc28 to settle. Therefore, it becomes possible to raise the possibility of obtaining the voltage sources mpc21 to mpc28 that satisfy the impedance matching condition or the harmonic termination condition.

Next, a procedure of the design support apparatus 10 will be described using a flowchart.

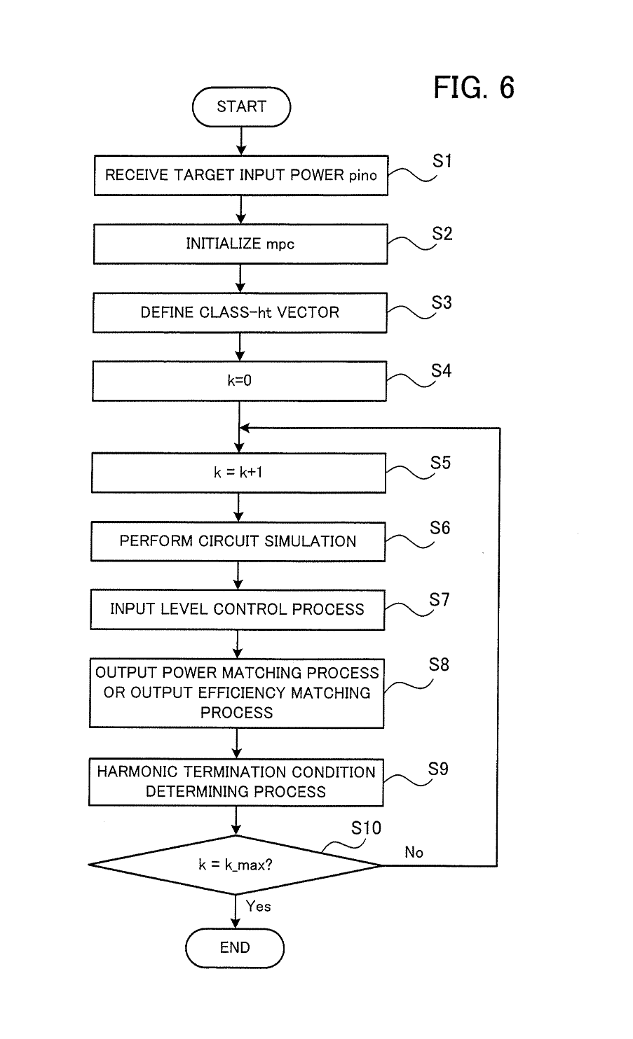

FIG. 6 is a flowchart describing the procedure of the design support apparatus of the second embodiment.

[Step S1] The main control unit 11 receives an input of the target input power pino defined by the designer. Subsequently, the flow proceeds to step S2.

[Step S2] The main control unit 11 initializes the voltage values mpc(1) to mpc(8) of the voltage sources mpc21 to mpc28. Subsequently, the flow proceeds to step S3.

[Step S3] The main control unit 11 defines a class-ht vector categorized in class-F and inverse class-F. Subsequently, the flow proceeds to step S4.

[Step S4] The main control unit 11 sets the parameter k=0 indicating the number of iterations. Subsequently, the flow proceeds to step S5.

[Step S5] The main control unit 11 increments the parameter k by 1. Subsequently, the flow proceeds to step S6.

[Step S6] The main control unit 11 transmits an instruction to the simulation executing unit 12 to perform simulation of the circuit model under inspection 20. According to the instruction, the simulation executing unit 12 performs simulation of the circuit model under inspection 20. Upon completion of the simulation of the circuit model under inspection 20, the main control unit transmits an instruction to the equivalent circuit model generating unit 13 to generate an equivalent circuit model. According to the instruction, the equivalent circuit model generating unit 13 generates the equivalent circuit model based on the simulation result. Subsequently, the main control unit 11 transmits, to the voltage adjusting unit 14, a voltage adjustment instruction including output power matching or output efficiency matching provided by the designer. Subsequently, the flow proceeds to step S7.

[Step S7] According to the voltage adjustment instructions from the main control unit 11, the input voltage adjusting unit 14a calculates the equations (1) and (2) to determine the voltage value mpc′(1) of the voltage source mpc21. Subsequently, the flow proceeds to step S8.

[Step S8] According to the voltage adjustment instruction from the main control unit 11, the impedance matching unit 14b determines the voltage value mpc′(5) of the voltage source mpc25, according to the output power matching or output efficiency matching instructed at step S6. As described above, the impedance matching unit 14b calculates the equations (3) to (6) when determining the voltage value mpc′(5) of the voltage source mpc25 with output power matching. In addition, the impedance matching unit 14b calculates the equation (3) and equations (7) to (9) when determining the voltage value mpc′(5) of the voltage source mpc25 with output efficiency matching. Subsequently, the flow proceeds to step S9.

[Step S9] According to the voltage adjustment instruction from the main control unit 11, the harmonic termination condition determining unit 14c calculates the equations (12) to (15) based on the class-ht vector defined at step S3 to determine the voltage values mpc(2) to mpc(4) and the voltage values mpc(6) to mpc(8). Subsequently, the flow proceeds to step S10.

[Step S10] The main control unit 11 determines whether or not the parameter k coincides with a predetermined value (k_max). When the parameter k coincides with k_max (Yes at step S10), the process of FIG. 6 is terminated. When the parameter k does not agree with k_max (No at step S10), the flow returns to step S5 and the processes of and after step S5 are continuously performed. Description of the procedure of FIG. 6 is thus completed. The order of processing by the design support apparatus 10 is not limited to that of FIG. 6.

As thus described above, the design support apparatus 10 obtains respective voltage values mpc(1) to mpc(8) of the voltage sources mpc21 to mpc28 based on the simulation result. Therefore, it is possible to obtain a combination of the fundamental wave and harmonic waves faster than before.

In addition, defining k_max and repeating the calculation of each of the fundamental wave and harmonic waves until they settle to some extent makes it possible to increase the reliability of the obtained fundamental wave and harmonic waves.

### Third Embodiment

In the following, a design support apparatus of a third embodiment will be described focusing on the difference from the second embodiment described above and omitting description of similar items.

The third embodiment is different from the second embodiment in terms of the control method of the main control unit 11.

The control method of the main control unit 11 of the third embodiment is different from that of the second embodiment in terms of the determination method of the voltage values mpc(1) to mpc(8). In the following, a procedure of the design support apparatus 10 of the third embodiment will be described using a flowchart.

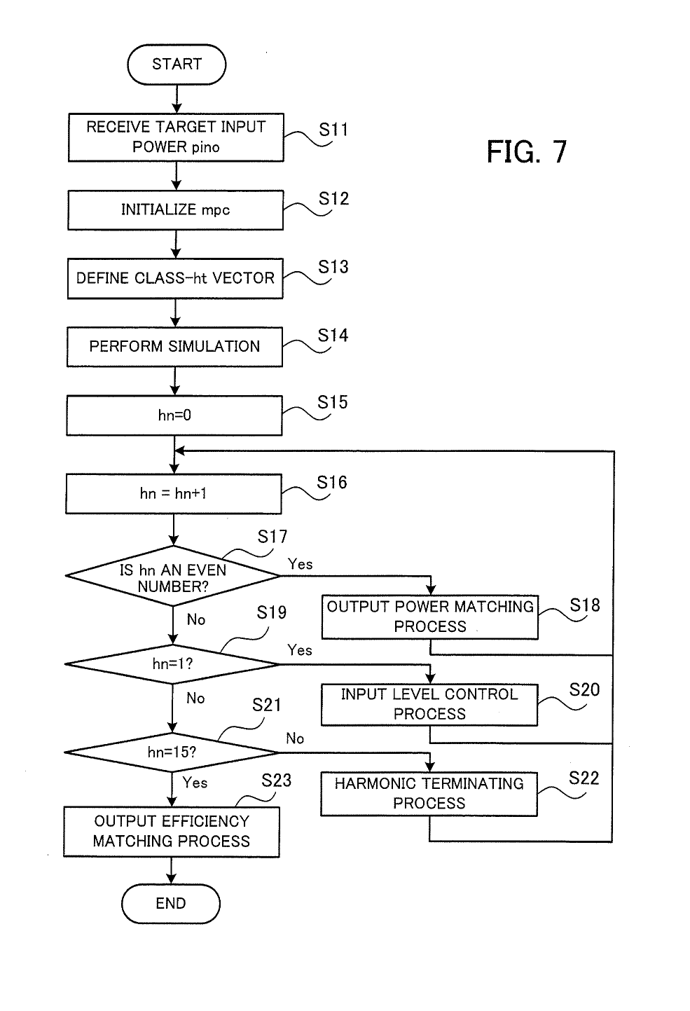

FIG. 7 is a flowchart describing the procedure of the design support apparatus of the third embodiment.

[Step S11] The main control unit 11 receives an input of the target input power pino defined by the designer. Subsequently, the flow proceeds to step S12.

[Step S12] The main control unit 11 initializes the voltage sources mpc(1) to mpc(4) at the input side and the voltage sources mpc(5) to mpc(8) at the output side. Subsequently, the flow proceeds to step S13.

[Step S13] The main control unit 11 defines a class-ht vector of class-F and inverse class-F. Subsequently, the flow proceeds to step S14.

[Step S14] The main control unit 11 transmits an instruction to the simulation executing unit 12 to perform simulation of the circuit model under inspection 20. According to the instruction, the simulation executing unit 12 performs simulation of the circuit model under inspection 20. Upon completion of the simulation of the circuit model under inspection 20, the main control unit transmits an instruction to the equivalent circuit model generating unit 13 to generate the equivalent circuit model 30. According to the instruction, the equivalent circuit model generating unit 13 generates the equivalent circuit model 30 based on the simulation result. Subsequently, the flow proceeds to step S15.

[Step S15] The main control unit 11 prepares a parameter hn indicating the order. The main control unit sets the initial value of the parameter hn to 0. Subsequently, the flow proceeds to step S16.

[Step S16] The main control unit 11 increments the parameter hn by 1. Subsequently, the flow proceeds to step S17.

[Step S17] The main control unit 11 determines whether or not the value of the parameter hn is an even number. When the value of the parameter hn is an even number (Yes at step S17), the flow proceeds to step S18. When the value of the parameter hn is not an even number (No at step S17), the flow proceeds to step S19.

[Step S18] According to the voltage adjustment instruction from the main control unit 11, the impedance matching unit 14b determines the voltage value mpc′(5) of the voltage source mpc25 with output power matching. Subsequently, the flow proceeds to step S16.

[Step S19] The main control unit 11 determines whether or not the value of the parameter hn is 1. When the value of the parameter hn is 1 (Yes at step S19), the flow proceeds to step S20. When the value of the parameter hn is not 1 (No at step S19), the flow proceeds to step S21.

[Step S20] According to the voltage adjustment instruction from the main control unit 11, the input voltage adjusting unit 14a calculates the equations (1) and (2) to determine the voltage value mpc′(1) of the voltage source mpc21. Subsequently, the flow proceeds to step S16.

[Step S21] The main control unit 11 determines whether or not the value of the parameter hn is 15. When the value of the parameter hn is 15 (Yes at step S21), the flow proceeds to step S23. When the value of the parameter hn is not 15 (No at step S21), the flow proceeds to step S22.

[Step S22] According to the voltage adjustment instruction from the main control unit 11, the harmonic termination condition determining unit 14c calculates the equations (10) to (13) to determine the voltage values mpc(2) to mpc(4) and the voltage values mpc(6) to mpc(8).

The value of the argument i of mpc is changed according to the value of the parameter hn. For example, when the parameter is hn=3, the argument is set as i=6. When the parameter is hn=5, the argument is set as i=7. When the parameter is hn=7, the argument is set as i=8. When the parameter is hn=9, the argument is set as i=2. When the parameter is hn=11, the argument is set as i=6. When the parameter is hn=13, the argument is set as i=4. This is because the main source of harmonic waves is the output terminal of the device model 21, and the termination condition of harmonic waves of lower orders has a larger effect. Upon completion of the harmonic termination procedure, the flow proceeds to step S16.

[Step S23] According to the voltage adjustment instruction from the main control unit 11, the impedance matching unit 14b determines the voltage value mpc′(5) of the voltage source mpc25 with output efficiency matching. Subsequently, the procedure of FIG. 7 is terminated. The order of processing by the design support apparatus 10 is not limited to that of FIG. 7.

According to the design support apparatus 10 of the third embodiment, a similar effect to the design support apparatus 10 of the second embodiment is obtained. According to the design support apparatus 10 of the third embodiment, the possibility that the voltage values mpc(1) to mpc(8) settle may be further raised in comparison with the second embodiment. In addition, it is possible to determine the voltage values mpc(1) to mpc(8) with an intention of satisfying both the efficiency and the power value of the output power of the circuit model under inspection 20.

In the third embodiment, simulation is performed once and the procedure is performed based in the result of the simulation performed. However, as described in the second embodiment, the circuit simulation may be performed more than once. In such an occasion, the natural gradient method may be used. In addition, as a solution of the multivariable non-linear problem, a common Genetic Algorithm or Simulated Annealing may be used.

The procedure performed by the design support apparatus 10 may be distributed across a plurality of devices. For example, a device may perform circuit simulation of the circuit model under inspection 20 to generate the equivalent circuit model 30, whereas another device may obtain the amplitude and the phase of the voltage sources mpc21 to mpc28 using the equivalent circuit model 30.

In each of the aforementioned embodiments, although an example of calculating the values of the voltage sources which output the fundamental wave and the second to the fourth-order harmonic waves is described, the values of voltage sources which output the fifth or higher-order harmonic waves may also be calculated.

The processing function described above may also be realized by a computer. In such a case, a program describing the processing of the functions included in the design support apparatuses 1 and 10 is provided. Executing the program by a computer realizes the processing function on the computer. The program describing the processing may be stored on a computer-readable storage medium. As a computer-readable storage medium, there are a magnetic memory device, an optical disk, a magneto-optical storage medium, a semiconductor memory, or the like. As a magnetic memory device, there are a hard disk drive, a flexible disk (FD), a magnetic tape, or the like. As an optical disk, there are a DVD, a DVD-RAM, a CD-ROM/RW, or the like. As a magneto-optical storage medium, there is a MO (Magneto-Optical disk), or the like.

When distributing a program, a portable storage medium having the program stored thereon such as a DVD, a CD-ROM, or the like, for example, is sold. In addition, the program may be stored in a storage device of a server computer, and the program may be transferred to other computers from the server computer via a network.

A computer executing a program stores, in a storage device thereof, a program recorded on a portable storage medium or a program transferred from a server computer, for example. The computer then reads the program from the storage device thereof and performs a procedure according to the program. The computer may also read the program directly from the portable storage medium and perform a procedure according to the program. In addition, the computer may also perform, each time a program is transferred from the server computer connected via a network, a procedure according to the received program.

In addition, at least a part of the processing functions described above may also be realized by an electronic circuit such as a DSP (Digital Signal Processor), an ASIC (Application Specific Integrated Circuit), a PLD (Programmable Logic Device), or the like.

The voltage of a voltage source in a non-linear high frequency circuit may be obtained by calculation.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A design support method comprising:
determining, by a design support apparatus, parameters indicating a relation among voltages and currents at input and output of each of a non-linear device model provided in a circuit model under inspection and a circuit model of a passive element connected to the non-linear device model;
calculating, by the design support apparatus, a voltage of a voltage source providing a fundamental wave of the circuit model under inspection, based on a given input power condition and an impedance matching condition for the circuit model under inspection and the calculated parameters; and
calculating, by the design support apparatus, a voltage of a voltage source providing a harmonic wave of the circuit model under inspection, based on a given harmonic termination condition and the determined parameters.

2. The design support method according to claim 1, wherein the design support apparatus calculates the voltage of the voltage source providing the fundamental wave and the voltage of the voltage source providing the harmonic wave, based on the parameters of an equivalent circuit model obtained as a result of simulating the device circuit model under inspection by the design support apparatus.

3. The design support method according to claim 2, wherein the design support apparatus simulates the circuit model under inspection again using the voltage of the voltage source providing the fundamental wave and the voltage of the voltage source providing the harmonic wave obtained by calculation and, based on the parameters of the equivalent circuit model obtained, calculates the voltage of the voltage source providing the fundamental wave and the voltage of the voltage source providing the harmonic wave again.

4. The design support method according to claim 2, wherein the design support apparatus calculates the voltage of the voltage source providing the fundamental wave of the present iteration which maximizes the output power of the equivalent circuit model, based on the voltage of the voltage source providing the fundamental wave obtained by calculation of the previous iteration and the parameters of the circuit model of the passive element, and simulates the circuit model under inspection again using the voltage obtained by calculation.

5. The design support method according to claim 4, wherein the parameters are parameters of a two-terminal pair circuit of the circuit model of the passive element.

6. The design support method according to claim 2, wherein the design support apparatus calculates the voltage of the voltage source providing the fundamental wave of the present iteration which maximizes the efficiency of the output power of the equivalent circuit model, based on the voltage of the voltage source providing the fundamental wave obtained by calculation of the previous iteration and the parameters of the circuit model of the passive element, and simulates the circuit model under inspection again using the voltage obtained by calculation.

7. The design support method according to claim 2, wherein the design support apparatus calculates the voltage of the voltage source providing the harmonic wave of the present iteration, based on the voltage of the voltage source providing the harmonic wave obtained by calculation of the previous iteration and the parameters of the circuit model of the passive element, and simulates the circuit model under inspection again using the voltage obtained by calculation.

8. The design support method according to claim 2, wherein the design support apparatus calculates the voltage of the voltage source providing the fundamental wave which maximizes the efficiency of the output power of the equivalent circuit model, based on the parameters of the circuit model of the passive element and the voltage of the voltage source providing the fundamental wave obtained by repeating, a plurality of times, the process of calculating the voltage of the voltage source providing the fundamental wave of the present iteration which maximizes the output power of the equivalent circuit model, based on the voltage of the voltage source providing the fundamental wave obtained by calculation of the previous iteration and the parameters of the circuit model of the passive element.

9. A computer-readable storage medium storing a computer program, the computer program causing a computer to perform a procedure comprising:
determining parameters indicating a relation among voltages and currents at input and output of each of a non-linear device model provided in a circuit model under inspection and a circuit model of a passive element connected to the non-linear device model;
calculating a voltage of a voltage source providing a fundamental wave of the circuit model under inspection, based on a given input power condition and an impedance matching condition and the calculated parameters; and
calculating a voltage of a voltage source providing a harmonic wave of the circuit model under inspection, based on a given harmonic termination condition and the determined parameters.

10. A design support apparatus comprising a processor configured to perform a procedure including:
determining parameters indicating a relation among voltages and currents at input and output of each of a non-linear device model provided in a circuit model under inspection and a circuit model of a passive element connected to the non-linear device model;
calculating a voltage of a voltage source providing a fundamental wave of the circuit model under inspection, based on a given input power condition and an impedance matching condition and the calculated parameters; and
calculating a voltage of a voltage source providing a harmonic wave of the circuit model under inspection, based on a given harmonic termination condition and the determined parameters.
